(19) United States
(12) Patent Application Publication
(10) Pub. No.: US 2006/0089860 A1
(43) Pub. Date: Apr. 27, 2006

(54) System and method for creating a favorable risk pool for portability and conversion life insurance programs

(76) Inventor: Barry Fitzmorris, Malibu, CA (US)

Correspondence Address: Mark E. Wiemelt, Esq.;Ste. 3300, 10 S. LaSalle St., Chicago, IL, 60603, US

(21) Appl. No.: 10/970,576

(22) Filed: Oct. 21, 2004

(51) Int. Cl. G06Q 40/00

(52) U.S. Cl. 705/4

(57) ABSTRACT

A method of providing portability and conversion life insurance plans to departing employees is disclosed. The method comprises the steps of establishing risk parameters for pricing an insurance policy, collecting data regarding a departing employee's individual risk level upon termination of employment, assigning the departing employee a rating based on risk level, and offering a rate based on the departing employee's rating, where low-risk individuals pay a lower premium than do higher-risk individuals. The method results in the retention within the plan of low-risk individuals who might otherwise opt for another policy with a more competitive rate. Implementation of the method thereby creates a more favorable risk pool of insured individuals and represents a tremendous increase in efficiency compared to the way portability and conversion insurance programs are conventionally managed.

### BACKGROUND OF THE INVENTION

1. Field of the Invention

The present invention relates to the field of insurance, particularly to a method of providing a more cost-effective and efficient means of providing portability and conversion life insurance programs by creating a more favorable risk pool among participants.

2. The Prior Art

A sizable percentage of the public carries life insurance under group plans sponsored by employers. In today's mobile society, it is increasingly important for individuals to have the ability to continue insurance coverage and other benefits upon leaving a company. Portability and conversion life insurance policies which allow individuals to convert from coverage under a group plan to coverage under an individual whole life or term plan are an important and popular method of achieving continuing life insurance coverage after the termination of employment.

Portability and conversion life insurance policies are well known in the art and are offered by many insurers. However, plans currently on the market do not take advantage of available economic opportunities and often ignore financial realities of the risk pools created by the implementation of standard plans.

Group plans typically involve no scrutiny of the individuals to be covered and require no or limited medical questionnaires or exams to assess the specific risk presented by any particular person. Instead, group plans allow insurers to spread the risk among a large number of low-, average- and high-risk individuals and to set a premium based on the risk profile of the overall group. As a result, the premium under a group plan tends to be better than what a high-risk individual could obtain under an individual plan and worse than what a low-risk individual could obtain individually. However, because part of the premium cost is typically subsidized by the employer, the group rate during the term of employment tends to be lower than what medium and high risk individuals could obtain individually.

This ceases to be the case once a low-risk individual leaves the company. Since conventional portability or conversion policies are based on the average risk level of the group, an individual with a better risk can obtain a cheaper rate of insurance by forgoing the portable insurance plan and taking out an individual policy. Conversely, the portable plan represents the best rate obtainable by a high-risk individual. The result is that portability or conversion policies effectively separate terminated employees into two groups: low-risk individuals who have economic incentive to forgo the policy, and high-risk individuals who have economic incentive to stay with the policy. Inevitably, the low-risk individuals disappear, leaving the underwriters of the portable plan with a pool of high-risk individuals paying a level of premiums insufficient to make the plan profitable.

An insurance program's loss ratio is the ratio of claims paid out by the insurer to premiums taken in. A loss ratio of 100% represents the break even point, where claim payments are exactly equal to premiums received. A loss ratio above 100% represents the unfavorable situation where claim payments exceed premium payments. A ratio under 100% represents the favorable situation where premium payments exceed claim payments. Understandably, insurers strive to maintain programs with a loss ratio under 100%. However, insurers historically have had difficulty achieving this for portability or conversion insurance programs. A typical program might offer departing employees portability or conversion life insurance at a blanket rate of 20% or more above the rate paid during their term of employment. This type of rate structure can result in a very unprofitable loss ratio of 200% or more.

The implementation of conventional portability and conversion plans drives away low-risk individuals and creates a pool composed of disproportionately high-risk individuals. A need exists for a method of implementing such programs that takes into account the economic relationship between mortality risks and premium rates so that a more favorable risk pool can be created and maintained.

### SUMMARY OF THE INVENTION

The present invention is a method of providing portability and conversion insurance coverage which structure premium rates to known risk factors and does not cause low-risk individuals disincentive to participate in the program. This method avoids the creation of a risk pool composed of disproportionately high-risk individuals and makes such insurance programs much more cost effective.

The inventive concept encompasses two separate but related scenarios: (1) The individual participates in a basic group/employer-paid life insurance plan during the term of employment. A departing employee transitions to an individual plan by exercising the conversion privilege offered in the contract. (2) The individual participates in an optional group/employee-paid life insurance group plan during the term of employment. A departing employee transitions to an individual plan by exercising the portability privilege offered in the contract. The mechanism by which a participating employee transitions from a group to an individual plan is technically different under the two scenarios, but the inventive concept applies equally well to either scenario.

When a participating employee is terminated or voluntarily leaves the group plan, he completes a medical evaluation, which can range from a short medical questionnaire to a long, detailed medical survey to a complete physical exam. More detailed and stringent evaluations lead to more accurate assessments of risk, but any such information, even the limited quantity obtainable through a short questionnaire, improves the insurer's ability to make a risk determination. Participants are assigned a rating on the basis of the medical evaluation. If the results indicate the participant is a low medical risk, the participant ports or converts his insurance at a preferred rate. If the participant is a high medical risk, the participant ports or converts his insurance at a rate higher than the preferred rate but still lower than what the participant could obtain on the open market. Thus, low-risk participants no longer have incentive to forgo the plan.

In one embodiment of the procedure, low-risk former employees continue to pay the premiums at the rate offered under the group plan during the term of employment. This is known as the preferred rate. High-risk participants pay premiums at a rate that is 50% or more above the preferred rate. This embodiment can be expected to result in a much-improved loss ratio. For example, the loss ratio of the preferred group can be expected to run at about 30-70%, while that of the high-risk group can be expected to run at about 90-120%. Because the preferred individuals tend to outnumber those in the high-risk pool, the overall loss ratio can be expected to run well below 100%, a tremendous increase in efficiency compared to the way portability and conversion insurance programs are conventionally managed.

It is an object of this invention to offer a more cost-effective and efficient method of providing portability and conversion life insurance upon termination of employment.

It is further object of this invention to provide a method of providing portability and conversion insurance coverage plans, which capture the healthy, low-risk participants by offering a rate competitive with what could be found on the open market.

It is a further object of this invention to provide a method of providing portability and conversion insurance with a rate structure based on known mortality factors.

It is still a further object of this invention to provide a computer-based means of implementing the method.

It is an advantage of this invention that it describes a method of providing portability and conversion insurance plans such that their implementation does not create a risk pool composed of disproportionately high-risk individuals.

Further objects and advantages of the present invention will become apparent to those skilled in the art to which the invention relates, from the following embodiments described with reference to the accompanying drawings, the specification and claims.

### BRIEF DESCRIPTION OF THE DRAWINGS

The foregoing and other additional objects of the present invention will be readily appreciated by those skilled in the art upon gaining an understanding of the preferred embodiment as described in the following detailed description and shown in the accompanying drawings in which:

FIG. 1 depicts a flow diagram for a method of providing portability or conversion life insurance.

FIG. 2 is a block diagram illustrating one embodiment of an overall system in which the method may be implemented.

### DETAILED DESCRIPTION OF THE PREFERRED EMBODIMENT

While this present invention is susceptible of embodiments in many different forms, there are shown in the drawings and will be described in detail herein, a preferred embodiment, with like parts designated by like reference numerals and with the understanding that the present disclosure is to be considered as an exemplification of the principles of the present invention, and is not intended to limit the claims to the illustrated preferred embodiment.

Referring now to FIG. 1, the method 20 of providing portability or conversion life insurance is displayed in a flow diagram.

In the first step 22 of the method, the insurer decides what risk parameters will be relevant for pricing the policy and factors them into a computer program designed to calculate risk. Various mortality factors the insurer may take into account include, but are not limited to, age, gender, tobacco use, height, weight, family medical history, driving record, criminal record, recreational activities engaged in by the participant. The insurer can then decide how much detail is necessary to make proper risk assessments and how to acquire the necessary information from the participants and any other sources of information that may be available. Methods of collecting the data may include a brief questionnaire, an interview, a detailed medical survey, a comprehensive exam by a physician, or other such methods. The preferred embodiment makes use of a short questionnaire.

Upon termination of employment, the next step of the method 24 is to collect risk assessment data from the departing employee in the manner designated in the previous step. The data is entered into the system 40 where the individual's mortality risk is evaluated. Based on the level of risk presented, the departing employee is assigned a rating pursuant to step 26. The rating can be a quantitative numeric value or a qualitative description, e.g. preferred, standard, substandard, or whatever the insurer deems appropriate. The preferred embodiment contemplates only two ratings: preferred and standard. A profile is created for the departing employee which is uploaded to a searchable database 48 and stored. As the database is built, mortality information that is subsequently generated may be used to make further refinements to the risk parameters and better tailor the rates offered to the risk presented.

A rate of premium is offered based upon the assigned rating, with lower premiums offered to individuals presenting lower risk. In the preferred embodiment, the preferred-risk participants would be charged the same premium as was paid during the term of active employment. Standard-risk participants would be charged a premium 20% higher than that paid during employment. However, any number of ratings could be designated and other rate structures could be successfully put into practice. For example, the method would lend itself well to a continuous numeric rating system with a sliding scale of premium offered according to the rating, where lower mortality risks are offered lower premiums.

Any profit generated by the program could be shared with the sponsoring employer or the participating employees to make the program even more attractive.

An exemplary computer system 40 with which the present method may be implemented is shown in FIG. 2. The system 40 contains an input mechanism 44 such as a keyboard by which information about the departing employee is entered. The CPU 42 performs calculations to evaluate the departing employee's risk level, assign the employee a rating based on risk, and to generate an employee profile. The information and employee profile are stored in a database 48 with a search engine 46 which can be retrieved by a system user and sent to an output device 50 such as a printer. The data may also be accessed by an external user through a modem 52. The system 40 may also be used to coordinate and schedule medical exams and surveys used in the data collection step 24.

While the invention has been described in connection with a preferred embodiment, it will be understood that it is not intended that the invention be limited to that embodiment. On the contrary, it is intended to cover all alternatives, modifications and equivalents as may be included within the spirit and scope of the invention as disclosed.

As to the manner of usage and operation of the present invention, the same should be apparent from the above disclosure, and accordingly no further discussion relevant to the manner of usage and operation of the present invention shall be provided.

With respect to the above description then, it is to be realized that the present invention includes variations which are deemed readily apparent and obvious to one skilled in the art, and all equivalent relationships to those illustrated in the drawings and described in the specification are intended to be encompassed by the present invention.

Therefore, the foregoing is considered illustrative of only the principles of the present invention. Further, since numerous modifications and changes will readily occur to those skilled in the art, it is not desired to limit the claims to the exact construction and operation shown and described, and accordingly, all suitable modifications and equivalents may be resorted to, falling within the scope of the claims. Therefore the foregoing is considered illustrative of the principles of the present invention.

What is claimed is:

1. A method of designing an insurance program, comprising the steps of:
establishing risk parameters for pricing an insurance policy,
collecting data regarding a departing employee's individual risk level upon termination of employment,
assigning the departing employee a rating based on risk level, and
offering a rate based on the departing employee's rating, where low-risk individuals pay a lower premium than do higher-risk individuals.

2. The method of claim 1, wherein the insurance program is a portability life insurance program.

3. The method of claim 1, wherein the insurance program is a portability disability insurance program.

4. The method of claim 1, wherein the insurance program is a portability health insurance program.

5. The method of claim 1, wherein the step establishing risk parameters specifically factors in age, gender and smoking status.

6. The method of claim 1, wherein a departing employee is rated as a preferred risk or a standard risk and is offered a preferred premium or a standard premium in correspondence with the level of risk.

7. The method of claim 1, wherein a departing employee is assigned a numeric rating and is offered a premium on a sliding scale, where lower-risk employees are offered lower premiums.

8. The method of claim 1, wherein data collection is accomplished through the use of a brief questionnaire.

9. The method of claim 1, wherein data collection is accomplished via a physical examination.
